(19) United States
(12) Patent Application Publication
(10) Pub. No.: US 2018/0319518 A1
(43) Pub. Date: Nov. 8, 2018

(54) PROCESS FOR THE PRODUCTION OF VISCOUS FOODS EXHIBITING A REDUCED SEPARATION OF LIQUIDS CONTAINED THEREIN

(71) Applicant: DMK Deutsches Milchkontor GmbH, Zeven (DE)

(72) Inventors: Anneke HOLSTEN, Scheessel (DE); Heike KRETZSCHMAR, Sittensen (DE); Marina SCHOMACKER, Sittensen (DE); Rolf STEFFENS, Zeven (DE)

(21) Appl. No.: 15/955,165

(22) Filed: Apr. 17, 2018

(30) Foreign Application Priority Data
May 5, 2017 (EP) 17 169 614.9

(51) Int. Cl. B65B 3/04

(52) U.S. Cl. CPC B65B 3/04; A23C 19/076

(57) ABSTRACT

A process is suggested for the production of viscous foods exhibiting a reduced separation of liquids contained therein, comprising the following steps:

(a) Providing a viscous mass having an amount of enclosed liquid therein, and
(b) Filling the mass into the final packaging,
characterised in that vibrational energy is introduced in to the mass during the filling process.

### FIELD OF THE INVENTION

The invention is in the field of dairy products and relates to a process by means of which the separation of liquids from viscous foods can be reduced, specifically the whey separation of fresh cheese, particularly quark, and a device for performing the process.

### STATE OF THE ART

Viscous foods are characterised in that they hold liquid in a semi-solid network, which gradually escapes in the course of storage, accumulating at the bottom of the packaging. For example, during the production of quark the supernatant whey is separated from the quark after the curdling of the milk. However, a small portion of whey remains within the product. This portion may be reduced by, for example, wrapping the quark mass into pieces of cloth, allowing the whey to drain off, or by pressing the whey out of the product. The first version is time-consuming, the second one damages the texture of the quark, and, in addition, both alternatives do not lead to a complete separation. In the course of storage, the whey still contained in the product is separated, which is referred to as “whey separation”.

However, any consumer expects the product to be whey-free when opening a package of quark, because—regardless of the optical appearance—whey is not considered a valuable ingredient and is therefore discharged before consumption.

Whey separation is, therefore, also a quality feature according to the test requirements for milk and dairy products issued by the German Food Association (Deutsche Le-bensmittelgesellschaft—DLG). Products bearing a DLG award may be marked or advertised accordingly. In many cases, products which cannot present such certification are not marketed at all, which makes it clear that, particularly, the production of quark exhibiting a minimized whey separation is also of great economic interest.

A process is already known from DE 1909199 A1 (GERVAIS), by means of which the whey separation of fresh cheese can be improved: to this end, the curdled milk is treated by means of ultrasound and is then separated into quark and whey. In practice, however, ultrasonic treatment does not prove to be sufficient in order to produce a product that may be certified according to DLF requirements.

The task of the present invention was therefore to provide a possibly straightforward process, by means of which it is possible to significantly reduce the separation of liquids from viscous foods in general, and the whey separation of fresh cheese or quark in particular.

### DESCRIPTION OF THE INVENTION

A first subject matter of the invention relates to a process for the production of viscous foods exhibiting a reduced separation of liquids contained therein, comprising the following steps:

(a) Providing a viscous mass having an amount of enclosed liquid contained therein, and
(b) Filling the mass into the final packaging,
which is characterized in that vibrational energy is introduced into the mass during the filling process.

The present invention is based on the surprising finding that quark, the surface shape of which is planar, does not exhibit any whey separation, or just a very reduced one, in comparison with the same products having a cone-shaped dome after filling.

In this context, it should be noted that, from a physical-chemical perspective, fresh cheese, or quark, is a highly shear-sensitive, plastic micro-particle dispersion. During automatic filling, the filling nozzle injects the mass directly into the sales unit, in the process of which the nozzle performs a vertical movement. As a result, a surface shape is obtained having at least one cone-shaped dome, depending on the dosing spout.

In order to reduce whey separation, applicant concluded from its observations that it is desirable to fill the viscous masses in a manner that deviates from the previous state of the art, allowing a planar surface shape to be obtained. In this context, it was found that such surface shape may be obtained by introducing vibrational energy into the mass during the filling process.

Preferably, vibrational energy having a sinusoidal course is introduced into the mass, which may be performed using horizontal and/or vertical vibrations; horizontal and vertical vibrations which are performed simultaneously are preferred. For example, the frequency of the vibrations may be in the range from 10 to 1,000 Hz, and particularly about 20 to 100 Hz. In this process, the mass is subjected to vibrations—preferably during its passage through the filling nozzle—for a period of, for example, 1 to 30 seconds, particularly about 5 to 15 seconds.

The type and manner of how the vibrations are generated, or how the vibrational energy is introduced into the mass, has an influence on the amount of whey which is still being separated. For example, ultrasound has proven to be of little effect. However, with regard to the fact that filling should be performed using conventional high-performance filling machines, which can be retrofitted only to a limited degree, in contrast, it has shown to be advantageous to introduce vibrational energy into the mass by means of a free-swinging, self-circulating piston (which is part of the high-performance filling machine). In doing so, the frequency in which the piston swings can be controlled in a simple manner by means of compressed air, and the width in which the piston swings can be controlled by means of loading weights applied on the piston.

Finally, if desired, the final packaging units can be vibrated either individually, or after inserting them into a transport pallet, for example, by means of a conventional vibrating device as is described, for example, in EP 0658382 A1 (NETTER).

### BRIEF DESCRIPTION OF THE DRAWINGS

The present invention will be described in greater detail with reference to the accompanying drawings in which the efficiency of the claimed process is shown in the FIGS. 1 to 9:

FIGS. 1 A-C: Microphotography of conventional quark with a fat content of 40% by weight taken with a 20× objective having an image edge length of 319.5×319.5 μm. FIGS. 1A, 1B and 1C were taken in three different locations (position 1 (FIG. 1A), position 2 (FIG. 1B) and position 3 (FIG. 1C)) of the sample. The light surfaces correspond to protein, the dark ones to fat, air, whey and, particularly, cavities within the structure,

FIGS. 2 A-C: Microphotography of quark with a fat content of 40% by weight according to process of the present invention taken with a 20× objective having an image edge length of 319.5×319.5 μm. FIGS. 2A, 2B and 2C were taken in three different locations (position 1 (FIG. 2A), position 2 (FIG. 2B) and position 3 (FIG. 2C)) of the sample. The light surfaces correspond to protein, the dark ones to fat, air, whey and, particularly, cavities within the structure,

FIGS. 3 A-C: Microphotography of conventional quark with a fat content of 40% by weight taken with a 63× objective having an image edge length of 101.4×101.4 μm. FIGS. 3A, 3B and 3C were taken in three different locations (position 1 (FIG. 3A), position 2 (FIG. 3B) and position 3 (FIG. 3C)) of the sample. The light surfaces correspond to protein, the dark ones to fat, air, whey and, particularly, cavities within the structure,

FIGS. 4 A-C: Microphotography of quark with a fat content of 40% by weight according to process of the present invention taken with a 63× objective having an image edge length of 101.4×101.4 μm. FIGS. 4A, 4B and 4C were taken in three different locations (position 1 (FIG. 4A), position 2 (FIG. 4B) and position 3 (FIG. 4C)) of the sample. The light surfaces correspond to protein, the dark ones to fat, air, whey and, particularly, cavities within the structure,

FIGS. 5 A-C: Microphotography of conventional quark (skimmed milk quark) taken with a 20× objective having an image edge length of 319.5×319.5 μm. FIGS. 5A, 5B and 5C were taken in three different locations (position 1 (FIG. 5A), position 2 (FIG. 5B) and position 3 (FIG. 5C)) of the sample. The light surfaces correspond to protein, the dark ones to fat, air, whey and, particularly, cavities within the structure. The amount was, on average, about 10 ml per 250 g quark,

FIGS. 6 A-C: Microphotography of quark (skimmed milk quark) according to process of the present invention taken with a 20× objective having an image edge length of 319.5×319.5 μm. FIGS. 6A, 6B and 6C were taken in three different locations (position 1 (FIG. 6A), position 2 (FIG. 6B) and position 3 (FIG. 6C)) of the sample. The light surfaces correspond to protein, the dark ones to fat, air, whey and, particularly, cavities within the structure. The amount was, on average, less than 3 ml per 250 g quark,

FIGS. 7 A-C: Microphotography of conventional quark (skimmed milk quark) taken with a 63× objective having an image edge length of 101.4×101.4 μm. FIGS. 7A, 7B and 7C were taken in three different locations (position 1 (FIG. 7A), position 2 (FIG. 7B) and position 3 (FIG. 7C)) of the sample. The light surfaces correspond to protein, the dark ones to fat, air, whey and, particularly, cavities within the structure. The amount was, on average, about 10 ml per 250 g quark,

FIGS. 8 A-C: Microphotography of quark (skimmed milk quark) according to process of the present invention taken with 63× objective having an image edge length of 101.4×101.4 μm. FIGS. 8A, 8B and 8C were taken in three different locations (position 1 (FIG. 8A), position 2 (FIG. 8B) and position 3 (FIG. 8C)) of the sample. The light surfaces correspond to protein, the dark ones to fat, air, whey and, particularly, cavities within the structure. The amount was, on average, less than 3 ml per 250 g quark, and

FIG. 9: shows, on the left-hand side, a 12-tray with batches of quark according to the invention, and with conventional ones on the right-hand side.

### INDUSTRIAL APPLICABILITY

A further subject matter of the invention relates to a high-performance filling machine, which is characterized in that it has a freely swinging, self-reversing piston for the introduction of vibrational energy into the mass to be filled.

### EXAMPLES

### Example 1, Comparison Example V1

### Vibration Treatment of Quark

Quark with a fat content of 40% by weight was filled into end packaging units in a conventional, continuously operated high-performance dispensing device in a first step, and in another step, vibrational energy (vibration) was introduced through a free swinging, self-reversing piston for a period of less than 10 seconds per packaging unit in a similar device. While the conventional products exhibited a distinct cone-shaped dome, the products according to the invention were practically planar. 12 samples produced in either manner of 250 g each were packaged and stored in a pallet for 2 days. Subsequently, the packaging units were opened and the amount of separated whey was determined: in the conventional products, the amount was, on average, about 10 ml per 250 g quark, in the products of the invention it was below 5 ml.

Subsequently, micro-photographs were prepared by means of a confocal microscope. To this end, sample material was taken from each package and placed onto an object carrier. Three pictures of different locations were taken from each sample (FIGS. 1 to 4). The pictures taken with a 20× objective have an image edge length of 319.5×319.5 μm, while the pictures using a 63× objective are 101.4×101.4 μm.

### FIG. 1: Standard (20×)

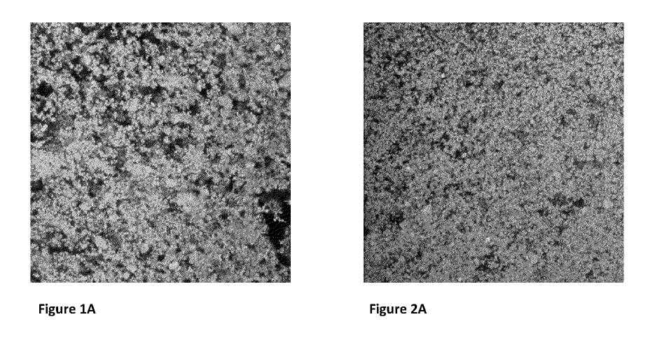

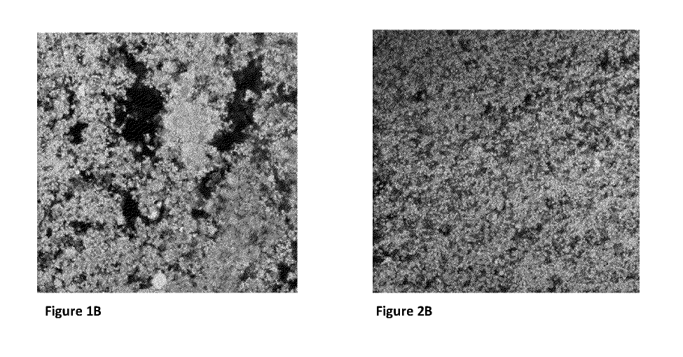

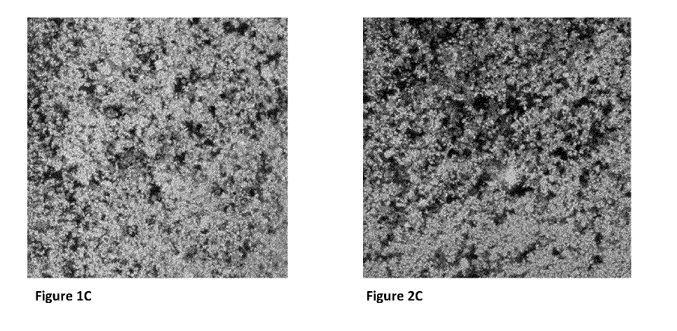

FIG. 2: According to the invention (20×)

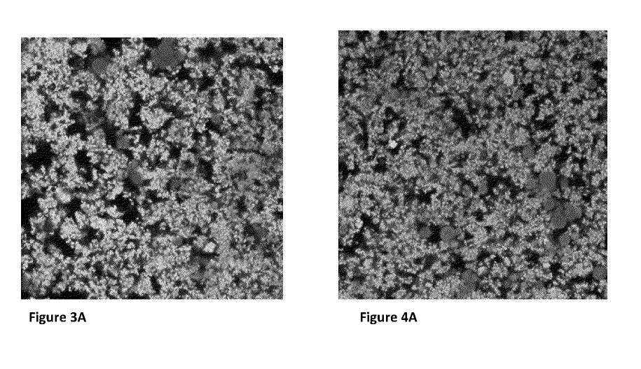

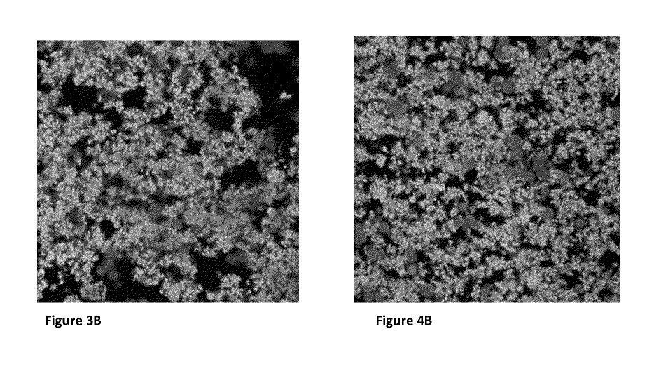

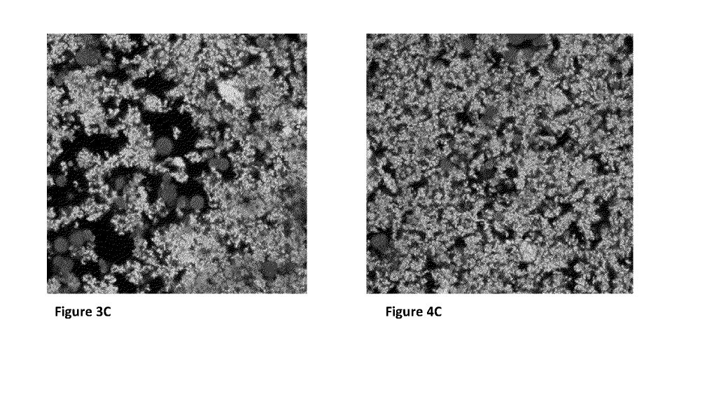

### FIG. 3: Standard (63×)

FIG. 4: According to the invention (63×)

The light surfaces correspond to protein, the dark ones to fat, air, whey and, particularly, cavities within the structure.

The cavities contain the whey which migrates from the top to the bottom; this is caused by capillary forces as a result of a sponge-like structure of the quark which forms in the course of product shelf life, leading to a separation at the bottom of the packaging unit.

The photographic comparison shows that, as a result of the introduction of vibrational energy, the quark is condensed, which reduces the number and the size of the cavities, as a result of which the whey separation is reduced as well.

### Example 2, Comparison Example V2

### Vibration Treatment of Skimmed Milk Quark

Example 1 and comparison example V1 were repeated using skimmed milk quark. In the conventional products, the amount was, on average, about 10 ml per 250 g quark; in the products according to the invention, it was less than 3 ml. Micro-photographs were taken also in this case:

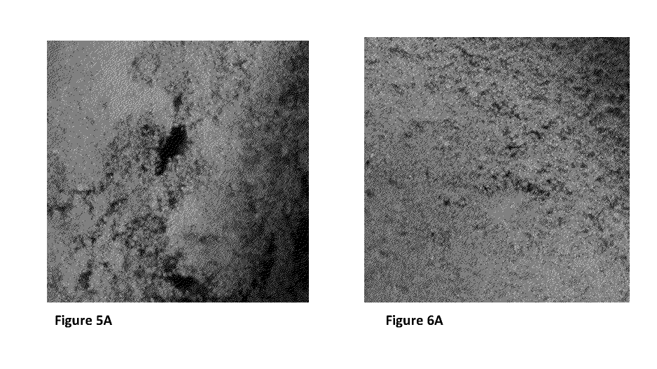

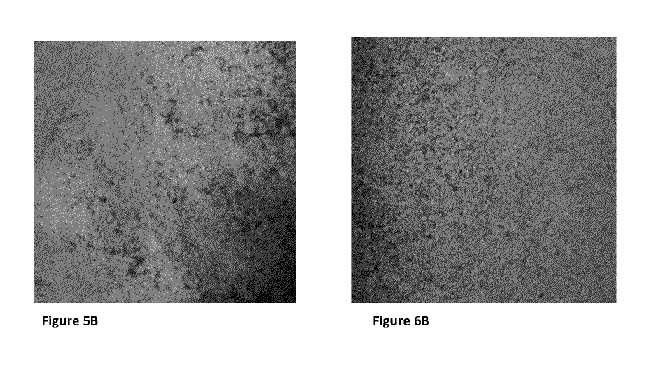

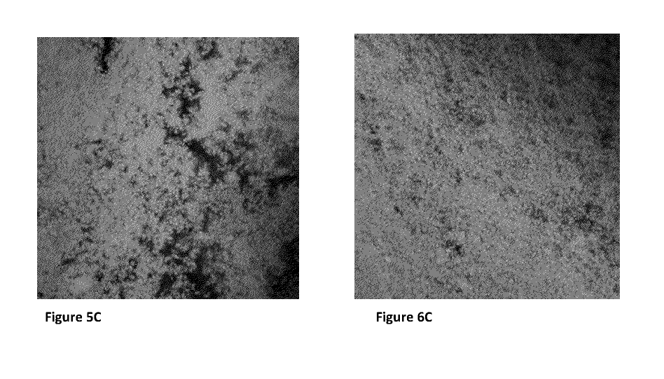

### FIG. 5: Standard (20×)

FIG. 6: According to the invention (20×)

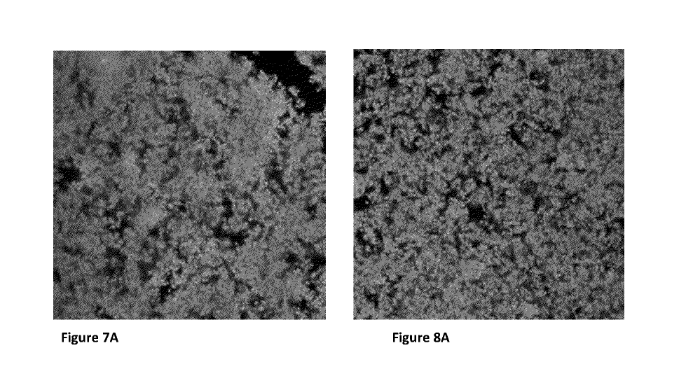

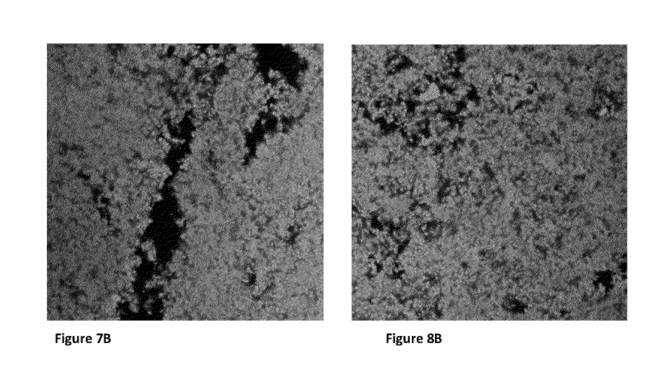

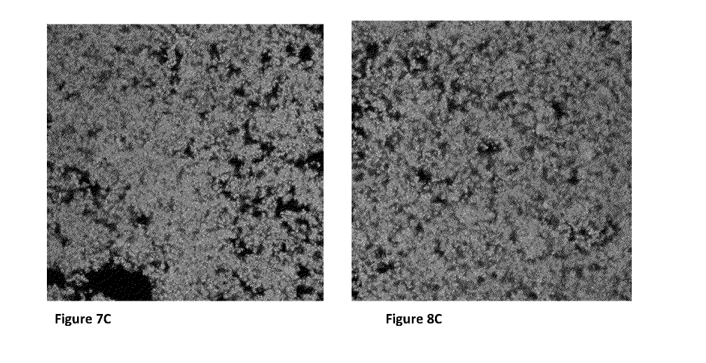

### FIG. 7: Standard (63×)

FIG. 8: According to the invention (63×)

### Example 3, Comparison Example V3

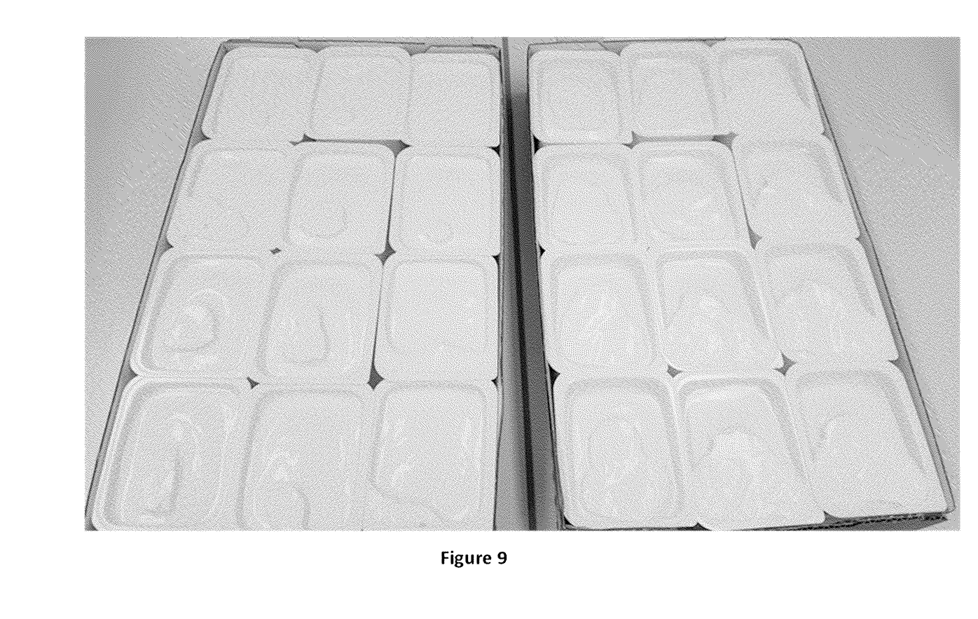

FIG. 9 shows, on the left-hand side, a 12-tray with batches of quark according to the invention, and with conventional ones on the right-hand side. It is clearly visible that the comparison products have a flat cone-shaped dome, while the products of the invention are practically planar.

1. A process for the production of viscous foods exhibiting a reduced separation of liquids contained therein, comprising the following steps:
(a) providing a viscous mass having an amount of enclosed liquid contained therein, and
(b) filling the mass into the final packaging,
wherein vibrational energy is introduced into the mass during the filling process.

2. The process of claim 1, wherein fresh cheese or quark is produced.

3. The process of claim 1, wherein vibrational energy having a sinusoidal course is introduced.

4. The process of claim 1, wherein the vibrational energy is introduced using horizontal and/or vertical vibrations.

5. The process of claim 1, wherein the vibrational energy is introduced with a frequency in the range of 20 to 70 Hz.

6. The process of claim 1, wherein the vibrational energy is introduced for a period of 1 to 30 seconds.

7. The process of claim 1, wherein the vibrational energy is introduced into the mass by a free-swinging, self-reversing piston.

8. The process of claim 7, wherein the piston is part of a high-performance filling machine.

9. The process of claim 7, wherein the frequency with which the piston swings is controlled by compressed air.

10. The process of claim 7, wherein the width in which the piston swings is controlled by applying loading weights on the piston.

11. The process of claim 1, wherein the final packaging units are vibrated either individually or after inserting them into a transport pallet.

12. High-performance filling machine, having, a free-swinging, self-reversing piston for the introduction of vibrational energy into the mass to be filled.
